(19) United States
(12) Patent Application Publication
(10) Pub. No.: US 2002/0159329 A1
(43) Pub. Date: Oct. 31, 2002

(54) Racetrack-shaped dynamic gravity flow blender

(76) Inventor: Jerry R. Johanson, San Luis Obispo, CA (US)

Correspondence Address: SINSHEIMER, SCHIEBELHUT, BAGGETT & TANGEMAN, 1010 PEACH STREET, SAN LUIS OBISPO, CA, 93401, US

(21) Appl. No.: 09/805,749

(22) Filed: Mar. 13, 2001

Related U.S. Application Data
(60) Provisional application No. 60/230,735, filed on Sep. 7, 2000.

(51) Int. Cl. B01F 5/24; B01F 9/02

(52) U.S. Cl. 366/228; 366/341

(57) ABSTRACT

Apparatus for blending particulate solids or liquids includes a blending vessel having a racetrack-shaped cross section at each elevation above its lower end. The racetrack-shaped cross section consists of two spaced opposed semicircles having ends that are joined by two spaced parallel line segments. Several embodiments of the apparatus are described; they all employ the racetrack-shaped blending vessel, which is highly effective in promoting mixing. In one embodiment the racetrack-shaped blending vessel is rotated about a horizontal axis so that the material passes through the vessel on each revolution. In another embodiment, a number of racetrack-shaped blending vessels are connected in a vertical sequence so that the material must pass through the blending vessels in succession.

### REFERENCE TO EARLIER APPLICATION

This application claims the benefit of U.S. Provisional Application No. 60/230,735 filed Sep. 7, 2000.

### BACKGROUND OF THE INVENTION

Blending of materials (liquids or solid particles) usually relies on mechanical means of moving one portion of the material with respect to another portion thus distributing streams of solids with respect to each other. The better mixers will frequently change relative movement direction to produce a crosswise reverse motion of the material. Usually mechanical impellers of various shapes are used, including mechanically activated ribbons and paddles. In some blenders, a series of stationary paddles are used and the material is allowed to drop through the paddles and thus produce a sequence of cuts and deflections of the stream in various directions to produce a mixing action. Sometimes the mechanical impellers are moved fast enough to throw the material. While this sometimes improves mixing, it often degrades the material and consequently does not produce a satisfactory mixing process.

### SUMMARY OF THE INVENTION

The blender of the present invention has a particular shape defined by the following features. At each elevation above the discharge opening, the cross section of the blender in any plane perpendicular to the axis of symmetry of the blender is racetrack-shaped; that is, the cross section consists of two opposed semicircles, spaced, and with their concave sides facing each other, the ends of the semicircles joined by parallel straight lines, resulting in a shape resembling that of a racetrack. The resulting blender necessarily has an axis of symmetry.

If the diameters of the semicircles are the same at all elevations, then the flat surfaces generated by the parallel straight lines will be vertical. On the other hand, if the diameters of the semicircles increase with increasing elevation, then the flat surfaces generated by the parallel straight lines converge downwardly. These two cases are illustrated, respectively, by the lower and the upper portions of the blender shown in FIG. 1. In both cases, the resulting structure is said to have one-dimensional convergence. In some embodiments described below, more than one blender module of this basic shape are combined in cascade, as shown in FIG. 3.

With the present invention, materials are mixed as they flow by gravity through a blending vessel of racetrack configuration and strike its multiple surfaces. The multiple surfaces of the blending vessel walls cause the material to disperse as it strikes the straight part of the racetrack. The curved portions of the racetrack then force this dispersed material back together, thus causing blending. The blending is enhanced when the blending vessel is designed to cause convergence of the material in only one direction at a time. Generally these directions are perpendicular to each other so that dispersion and mixing occur first in one direction and then in a direction perpendicular to the first. This one-dimensional convergence is not only useful to enhance blending, but also can produce bottom to top sequential discharge of material leaving the blending vessel.

The means for introducing material into the racetrack configuration blending vessel can be as simple as a single chute, or multiple feeders feeding multiple chutes.

In a simple, non-rotating embodiment, multiple blending opportunities are provided by stacking blending vessels and allowing material to fall by gravity from one vessel into the next, as in FIG. 3.

In another embodiment, shown in FIG. 4, a large closed introduction chamber affixed to the top of the blending vessel is alternately filled and emptied by gravity as the blending vessel and chamber are rotated as a unit about a horizontal axis. This configuration, in which the ends of both the blending vessel and the chamber are capped so as to contain the material, allows for the repeated entry of the same material into the same blending vessel as the assembly is rotated about a horizontal axis.

The multiple blending opportunities of the rotated embodiment are enhanced when the introduction chamber has the same size and shape as the blending vessel and is mounted in an inverted posture into the upper end of the blending vessel, as shown in FIG. 5. This provides a mixing opportunity with each half revolution. Blending in this dual racetrack-shaped blender configuration is further enhanced by a 90-degree rotation of the racetrack axis of one blending vessel with respect to the other.

The volume of material introduced into the blending vessel in a unit time affects the blending. Generally, a large flow rate is more effective than a smaller one provided that the flow rate is small enough to allow the dispersion to occur. In a non-rotating embodiment, the optimum volumetric flow rate is the gravity flow rate through the blending vessel when it is totally full. This ensures that the vessel will not plug while in use. In general, the flow rate through a stationary blending vessel should be between this optimum value and one quarter of the optimum value.

In the case where the blending vessel is rotated about a horizontal axis, the quantity of material entering the blending vessel per second is governed by the rotational speed of the blender assembly. In general, higher rotational speeds delay the entrance of the material into the blending vessel because the centrifugal force due to the rotation prevents the material in the introduction chamber from dropping into the blending vessel. The rotational rate (rpm) of the rotated version should be such that

$$rpm = \frac{30}{π} \sqrt{\frac{f g}{r}}$$

where f is a number between 0.3 and 0.9,

g is the gravitational constant,

r is the distance from the axis of rotation to the far end of the introduction chamber,

and π is 3.1416.

The novel features which are believed to be characteristic of the invention, both as to organization and method of operation, together with further objects and advantages thereof, will be better understood from the following description considered in connection with the accompanying drawings in which a preferred embodiment of the invention is illustrated by way of example. It is to be expressly understood, however, that the drawings are for the purpose of illustration and description only and are not intended as a definition of the limits of the invention.

### BRIEF DESCRIPTION OF THE DRAWINGS

FIG. 1, including FIGS. 1A, 1B, and 1C, shows the racetrack shape of the blender and a chute that introduces the material to the blender.

FIG. 1A is a front elevational view of the blender;

FIG. 1B is a top plan view of the blender with intersecting areas of the chute outlet and the blender outlet for more effective mixing. The one-dimensional convergence of the blender walls is readily apparent.

FIG. 1C is a side elevational view of the blender.

FIG. 2, including FIG. 2A and FIG. 2B, illustrates the dynamic interaction of the multifaceted walls of the blending vessel with the material introduced by the chute.

FIG. 2A is a front elevational view showing the spreading of the material as it impacts the upper flat sloping portion of the blending vessel's racetrack configuration. Also shown is the further change of velocity, material dispersion, and mixing as the material impacts the lower concave portion of the blending vessel's racetrack configuration. The figure shows the final mixing of the fully dispersed material as it exits the blending vessel's final racetrack configuration.

FIG. 2B is a side elevational view of the blender apparatus showing how some material immediately contacts the upper straight portion of the racetrack configuration while some material completely misses this portion and is propelled into the material sliding off of the upper flat racetrack portion, which produces a significant mixing of the dispersed material. The figure also shows how some of the material impacts onto the far side of the lower flat portion of the blending vessel's racetrack configuration. This material deflects back into the material sliding along the concave portion of the blending vessel's racetrack configuration.

FIG. 3, including FIG. 3A and FIG. 3B, show a series of three blending vessels, one above the other. The figure also shows multiple feeders and their associated chutes introducing two or more materials for mixing in the blending vessel.

FIG. 3A shows a front elevational view of the blending vessels;

FIG. 3B shows a side elevational view of the blending vessels;

FIG. 4, including FIG. 4A, FIG. 4B, and FIG. 4C show the blending vessel with an introduction chamber that has a diameter essentially the same as the top of the blending vessel.

FIG. 4A is a front elevational view of the assembly and shows a means of closing off the bottom of the blending vessel for a time so that the material can be recycled to the top of the blender by rotating the entire assembly about a horizontal axis. This allows the material to flow by gravity into the closed introduction chamber and to be re-circulated again into the blending vessel as the rotation continues.

FIG. 4B is a top plan view of the blending vessel, the introduction chamber and the rotation mechanism. The axis of the rotation is intentionally offset from the racetrack axis to improve the mixing in the blending vessel.

FIG. 4C is a side elevational view of the assembly.

FIG. 5, including FIG. 5A, FIG. 5B, and FIG. 5C, show a blending vessel and introduction chamber in which the introduction chamber is identical to the blending vessel and is separated from, but connected to, the blending vessel by a cylinder.

FIG. 5A is a front elevational view of the assembly.

FIG. 5B is a top plan view of the assembly and shows that the axes of the racetracks of the vessels are offset by about 90 degrees to improve the blending as material is dropped from one vessel into the other as the assembly is rotated about a horizontal axis.

FIG. 5C is a side elevational view of the assembly.

### DETAILED DESCRIPTION OF THE PREFERRED EMBODIMENT

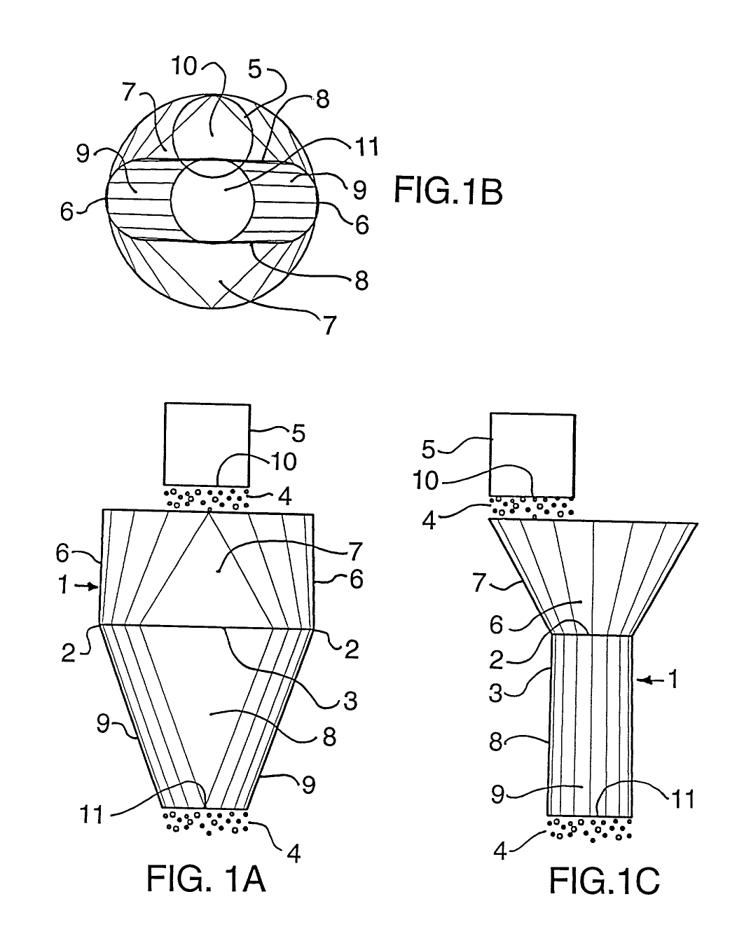

FIG. 1A illustrates the basic invention and shows a blending vessel in which each cross-section is a racetrack configuration composed of opposing semicircular end sections 2 and opposing straight parallel lines 3. Material to be blended is introduced into the vessel 1 by means of a chute 5 in such a manner that the material strikes the multiple surfaces of the vessel walls in such a way as to cause a variation of the progression velocity through the blending vessel, and to cause an interparticle dispersion of the material stream.

This dispersion is enhanced when the curved walls 6 and flat walls 7 of the racetrack configuration are arranged so that they converge in one direction at a time. For example, in the upper part of the blending vessel, curved walls 6 remain equidistant while flat walls 7 converge in the downward direction of FIG. 1A, as seen in FIGS. 1C and in the plan view of the apparatus in FIG. 1B. In the lower part of the blending vessel, the condition is reversed so that the straight portions of the racetrack forming flat walls 8 remain parallel while the curved portions of the racetrack forming walls 9 converge in the downward direction of FIG. 1A and FIG. 1C. This structure illustrates what is called one-dimensional convergence because only one dimension of the vessel walls converges at any given cross-section of the vessel. This one-dimensional convergence is especially effective for blending when the first convergent direction is the flat walls 7 of the upper part of the blending vessel of FIG. 1 followed by the convergence of the curved walls 9 of the lower part of the blending vessel of FIG. 1. One-dimensional convergence can also provide a bottom-to-top discharge of solids when the blending vessel is full and then emptied, provided the walls are steep enough.

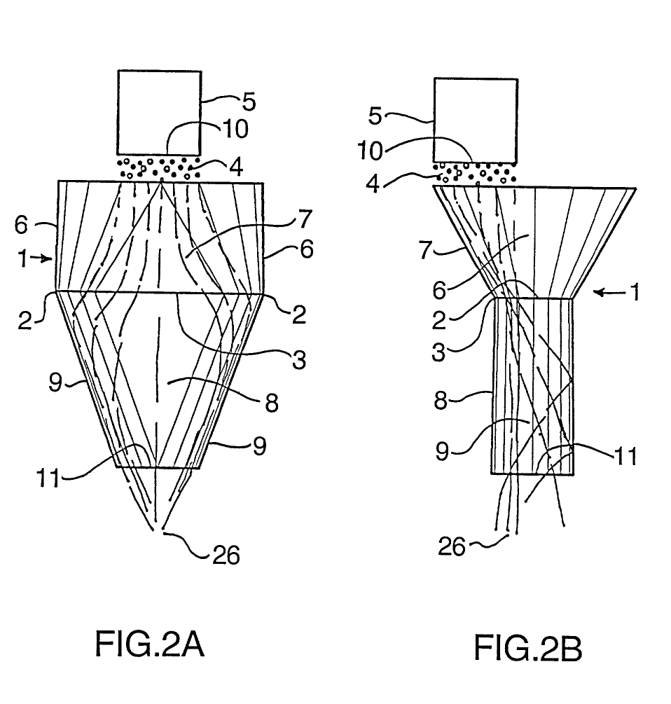

One means of increasing material dispersion is shown in FIGS. 1C and 1B, where the chute 5 is located so that outlet 10 of the chute 5 and the outlet 11 of the blending vessel partially overlap. This allows some of the material to immediately reach the outlet 11 and interact with other material that has been delayed by interaction with the sloping walls. The dispersion achieved by the apparatus of FIG. 1 is described pictorially in FIG. 2A and FIG. 2B. The trajectories of a number of particles 4 are indicated by flow lines. As the particles 4 leave the chute 5 the velocity is small and essentially vertical. The material near the wall 7 strikes the wall soon after exiting the chute 5 while the material furthest away from the wall 7 might never strike the wall 7 but instead might fall freely as it descends to the outlet 11. The material that does not strike the wall 7 interacts with the material sliding off the wall 7 in the vicinity of the intersection between walls 7 and 8 as seen in FIG. 2B. FIG. 2A illustrates how particles 4 from chute 5 disperse to the side as they strike the flat part 7 of the racetrack wall. As a result of this lateral dispersal, the material strikes the circular portion 9 of the wall at various vertical positions and velocities. The circular portion 9 of the wall directs the dispersed material back together, thus causing mixing. Dispersion occurs again as the material accelerates on the curved wall 9 toward the outlet. FIG. 2B shows some of the material striking the wall 8 and being deflected back into the dispersed stream of material, either falling freely or sliding on the curved wall 9.

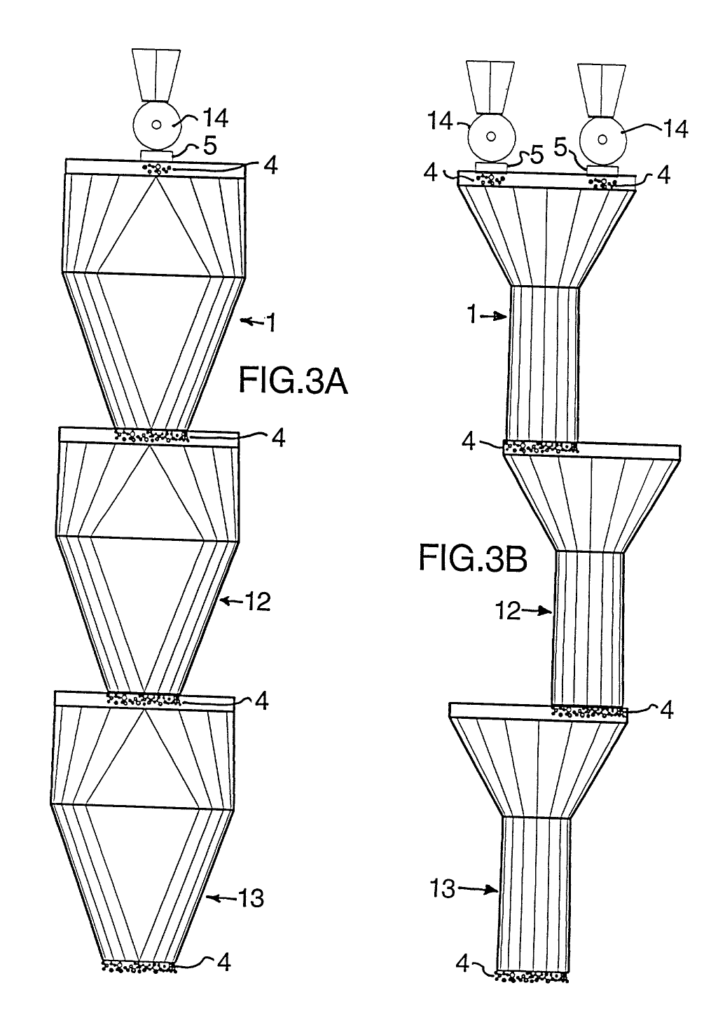

FIG. 3 shows a series of similar blending vessels 1, 12 and 13, each lower blending vessel receiving material 4 from the blending vessel immediately above it. The figure also shows multiple chutes 5 fed with feeders 14 to introduce multiple materials into the blender.

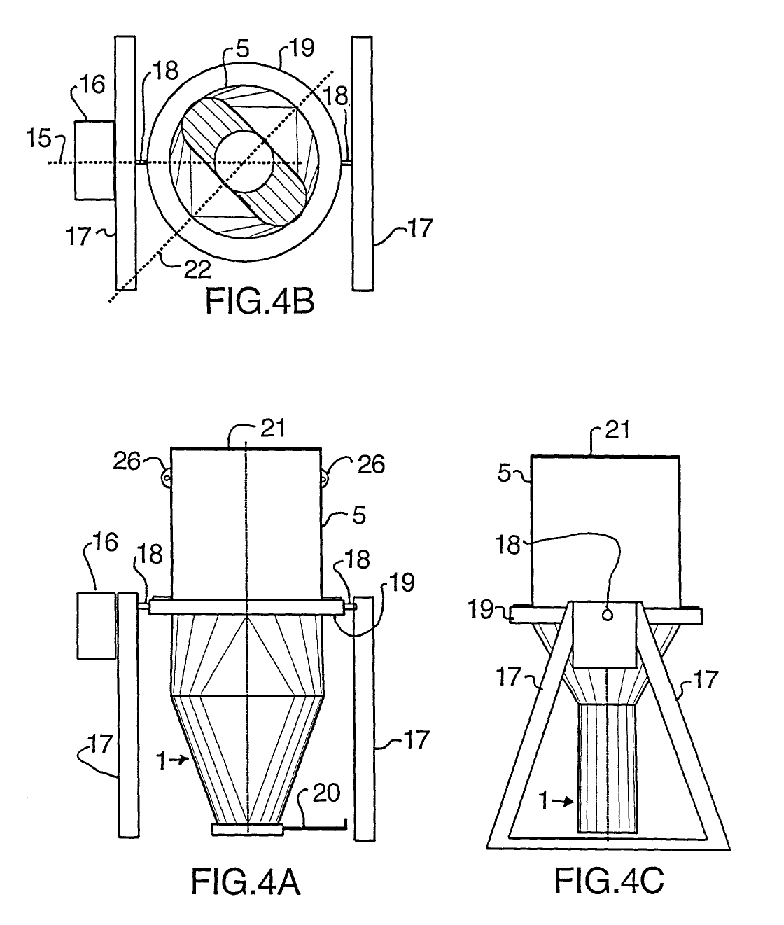

FIG. 4 shows the blending apparatus with a cylindrical introduction chamber 5 introducing material into the blending vessel 1. The diameter of the introduction chamber 5 equals the diameter of the top of the blending vessel 1. The introduction chamber 5 is attached to the upper end of the blending vessel and is closed off by a top 21. The chamber 5 is filled intermittently as the assembly is rotated about a horizontal axis 15 by a motor 16 supported by a frame 17. The blending vessel 1 and chamber 5 assembly are secured to the rotating motor shaft 18 by a support ring 19. The discharge opening of the blending vessel is closed off by the gate 20, thus allowing the blending cycle to repeat on each revolution. Lifting lugs 26 allow the blending vessel and chamber to be lifted from the rotational mechanism.

Blending in the blending vessel of FIG. 4 is improved when the major axis 22 of the racetrack is oriented at an angle with respect to the axis of rotation 15, as shown in FIG. 4B. The best results are obtained when that angle is approximately 45 degrees, however less than or greater than 45 degrees is also helpful.

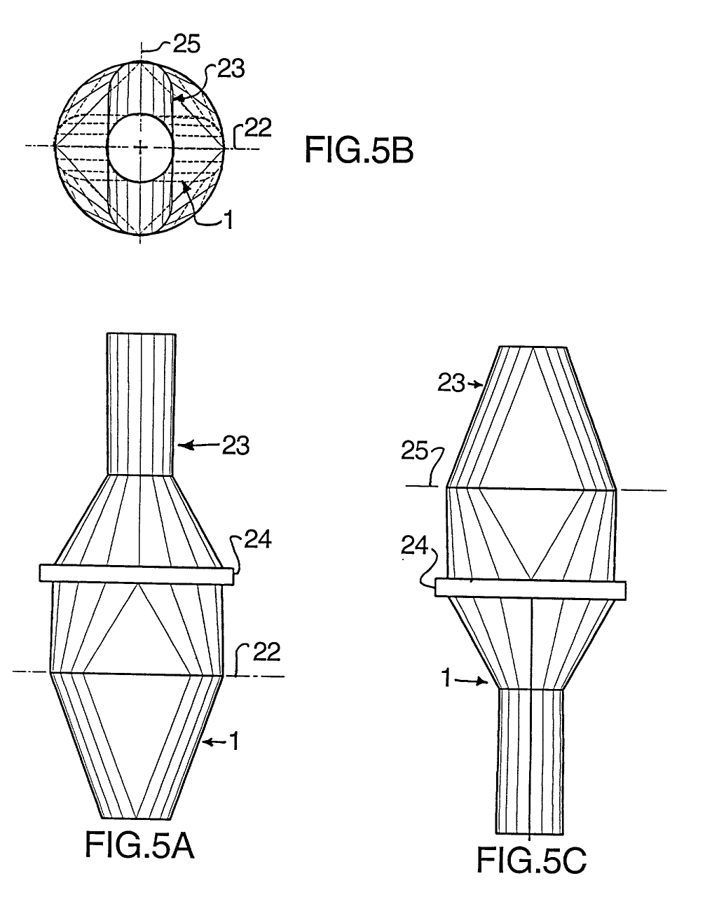

Because most of the blending occurs in the blending vessel 1, the shape of the chute 5 of FIGS. 1 and 2 and of the cylindrical chamber 5 of FIG. 4 is not important. It could be a cylinder, a cone, or another blending vessel 23 identical to the blending vessel 1, as shown in FIG. 5. The embodiment of FIG. 5 produces blending on each half rotation of the assembly. This is especially effective when the two vessels 1 and 23 are situated, as shown in FIG. 5, so that the major axes 22 and 25 of the racetracks are oriented at about 90 degrees from each other, as seen in the plan view of FIG. 5B. The two vessels are shown separated from each other by a short cylindrical transition 24. While this separation is not essential, it does help increase the effective volume of the blender and increases the dynamic mixing effects discussed above.

The foregoing detailed description is illustrative of several embodiments of the invention, and it is to be understood that additional embodiments thereof will be obvious to those skilled in the art. The embodiments described herein together with those additional embodiments are considered to be within the scope of the invention.

What is claimed is:

1. A blending apparatus comprising:
a blending vessel having an axis of symmetry and at all points along the axis of symmetry having a racetrack-shaped cross section in a plane perpendicular to the axis of symmetry, said racetrack-shaped cross section consisting of two opposed semicircles, spaced, and with their concave sides facing each other, the ends of the semicircles joined by parallel straight line segments, said blending vessel extending downward from an upper end to a lower end; and,
means for introducing into said blending vessel in a controllable manner materials that are to be blended, said means connected to the upper end of said blending vessel.

2. The blending apparatus of claim 1 wherein the diameters of the semicircles decrease in the downward direction.

3. The blending apparatus of claim 1 wherein the length of the parallel straight line segments decreases in the downward direction.

4. The blending apparatus of claim 1 wherein said blending vessel includes an upper part and a lower part and wherein, in the upper part the diameters of the semicircles decrease in the downward direction, and wherein, in the lower part the length of the parallel straight line segments decreases in the downward direction.

5. The blending apparatus of claim 1 wherein said means for introducing further comprise a feeder and a chute, said feeder discharging said materials into said chute, and said chute discharging into said blending vessel.

6. The blending apparatus of claim 5 wherein said chute is so positioned with respect to said blending vessel that portions of the material introduced into the blending vessel at a particular time take different paths through the blending vessel and arrive at the lower end at different times.

7. A blending apparatus comprising:
more than one identical blending vessels connected sequentially in a vertical direction so that material to be blended passes through them in succession, each of said more than one identical blending vessels having its own axis of symmetry and at all points along its axis of symmetry having a racetrack-shaped cross section in a plane perpendicular to the axis of symmetry, said racetrack-shaped cross section consisting of two opposed semicircles, spaced, and with their concave sides facing each other, the ends of the semicircles joined by parallel straight line segments.

8. The blending apparatus of claim 7 wherein the axes of symmetry of said more than one identical blending vessels are displaced laterally one from another.

9. The blending apparatus of claim 7 wherein the major axes of the racetrack-shaped cross sections of said more than one identical blending vessels are oriented in different directions.

10. The blending apparatus of claim 7 wherein each of said more than one identical blending vessels includes an upper part and a lower part, and wherein, in the upper part the diameters of the semicircles decrease in the downward direction, and wherein, in the lower part the length of the parallel straight line segments decreases in the downward direction.

11. The blending apparatus of claim 7 wherein one of said more than one identical blending vessels is uppermost, and further comprising means for introducing into said uppermost blending vessel in a controllable manner materials that are to be blended, said means connected to the upper end of the uppermost blending vessel.

12. The blending apparatus of claim 11 wherein said means for introducing further comprise a feeder and a chute, said feeder discharging said materials into said chute, and said chute discharging into the uppermost blending vessel.

13. A blending apparatus comprising:
a blending vessel having an axis of symmetry and at all points along the axis of symmetry having a racetrack-shaped cross section in a plane perpendicular to the axis of symmetry, said racetrack-shaped cross section consisting of two opposed semicircles, spaced, and with their concave sides facing each other, the ends of the semicircles joined by parallel straight line segments, said blending vessel extending downward from an upper end to a lower end; and,
means for rotating said blending vessel about an approximately horizontal axis.

14. The blending apparatus of claim 13 wherein the major axis of the racetrack-shaped cross sections of said blending vessel is oriented in a different direction from the direction of said approximately horizontal axis about which said blending vessel is rotated.

15. The blending apparatus of claim 14 in which the major axis is displaced in angle from the horizontal axis by an amount between 15 and 75 degrees.

16. The blending apparatus of claim 13 further comprising an introduction vessel for receiving and holding the material as the blending vessel is rotated to an inverted position, and for re-introducing the material to the blending vessel as the blending vessel is rotated to an upright position, said introduction vessel having a lower end connected to the upper end of the blending vessel and having an upper end.

17. The blending apparatus of claim 16 wherein said introduction vessel is cylindrical shaped, and is closed at its upper end.

18. The blending apparatus of claim 16 wherein said introduction vessel is a vessel identical in size and shape to said blending vessel and is joined to said blending vessel in an inverted posture.

19. The blending apparatus of claim 18 wherein said introduction vessel is joined to said blending vessel with the major axis of the racetrack-shaped cross section of said introduction vessel oriented at a different direction from the major axis of the racetrack-shaped cross section of said blending vessel.
